(19) United States
(12) Patent Application Publication
(10) Pub. No.: US 2025/0343402 A1
(43) Pub. Date: Nov. 6, 2025

(54) IN-LINE CONNECTION ASSEMBLY

(71) Applicant: MACLEAN POWER L.L.C., Fort Mill, SC (US)

(72) Inventor: Warren MARTIN, Abita Springs, LA (US)

(73) Assignee: MACLEAN POWER L.L.C., Fort Mill, SC (US)

(21) Appl. No.: 19/199,016

(22) Filed: May 5, 2025

Related U.S. Application Data
(60) Provisional application No. 63/642,869, filed on May 5, 2024.

(51) Int. Cl. H02G 7/00; H01H 31/00; H02G 1/02

(52) U.S. Cl. CPC H02G 7/00; H01H 31/00; H02G 1/02

(57) ABSTRACT

An in-line electrical assembly is provided and has a first clamp positioned at a first end portion and offset at a first angle. A second clamp is positioned at a second end portion and offset at a second angle. At least one insulator is positioned between the first end portion and the second end portion. A switch assembly is positioned between the first end portion and the second end portion. A clamp actuator extends below a conductor.

### CROSS-REFERENCE TO RELATED APPLICATIONS

This application claims the benefit of U.S. provisional application Ser. No. 63/642,869 filed May 5, 2024, the disclosure of which is hereby incorporated in its entirety by reference herein.

### TECHNICAL FIELD

The present application is related to an in-line electrical connection assembly to be mounted on conductors used in power distribution and transmission.

### BACKGROUND

In electrical distribution and transmission systems, it is sometimes useful to be able to connect an electrical assembly in-line along a conductor. Such in-line connections enable the integration of devices such as disconnect switches, which allow for the selective isolation of circuit segments, or in-line tap assemblies, which provide a means to divert electrical power from the main line to secondary circuits or equipment. These assemblies are often installed without severing the main conductor, thereby maintaining continuity of service while adding functionality. In-line connection assemblies must be both electrically and mechanically reliable, capable of withstanding system voltages, environmental conditions, and mechanical stresses encountered in overhead or underground installations. Furthermore, ease of installation, particularly under live-line or limited-access conditions, is a critical consideration in their design.

### SUMMARY

According to at least one embodiment, an in-line disconnect switch assembly is provided with a first clamp positioned at a first end portion and offset at a first angle. A second clamp is positioned at a second end portion and offset at a second angle. At least one insulator is positioned between the first end portion and the second end portion. A switch assembly is positioned between the first end portion and the second end portion.

In another embodiment, the first and second clamps each include a fastener. The fastener is tightened to move the first and second clamps from an open position to a closed position. A fastener torque-bearing surface is below a conductor on which the in-line switch is installed.

According to at least one embodiment, an in-line connection assembly is provided with a first end portion having a first conductor clamp and a second end portion having a second clamp. The first and second conductor clamps each may include a first jaw and a second jaw moveable relative to each other between an open position and a closed position where each conductor clamp is positioned to hold an electrical conductor between the first jaw and the second jaw. The first and second conductor clamps each include a clamp actuator extending below the first jaw and engaged with second jaw. Adjustment of the clamp actuator moves the clamp between the open and closed position. The assembly also includes at least one insulator positioned between the first end portion and the second end portion. The assembly also includes an electrical assembly positioned between the first end portion and the second end portion.

In another embodiment, the electrical assembly may be an in-line disconnect switch. In another embodiment, the electrical assembly may be an in-line tap.

In another embodiment, the first jaw may include a lower jaw positioned below the conductor and the second jaw may include an upper jaw moveable to clamp above the conductor.

In another embodiment, the first jaw may include an aperture through which the clamp actuator extends, and the clamp actuator is retained on the second jaw.

In another embodiment, the first and second jaw move linearly in a clamp direction offset from a generally vertical direction by a clamp angle being greater than 0-degrees. In another embodiment, the clamp angle is in the range of 30 to 60 degrees. In another embodiment, the first and second clamps are oriented at opposite angles relative to the generally vertical direction, where a first clamp angle is in the range of 30 to 60 degrees, and a second clamp is in the range of, −30 to −60 degrees.

In another embodiment, when in the open position, the first clamp has an opening facing a right lateral side of the assembly, and when the second clamp is in the open position, the second clamp has an opening facing a left lateral side of the assembly.

In another embodiment, the first end portion may include a first bracket and the second end portion may include a second bracket, where the first and second brackets support the assembly on the conductor as the clamps are moved to the closed clamp position. In another embodiment, the first and second brackets may include a hook extending from an the end body of the first and second end portions, where the first hook has a hook opening to the right side and the second hook has a hook opening to the left side.

In another embodiment, the first and second clamp actuators each may include a threaded fastener, where the threaded fastener is tightened to move the clamp to the closed position. In another embodiment, the fastener may include a curved fastener having two threaded portions at distal ends. The fastener is retained on the second jaw along a curved segment. In another embodiment, the fastener may include a nut engaging a threaded portion of a bolt, where rotating the nut relative to the bolt moves the clamp between the open and closed positions.

According to at least one embodiment, a method of assembling an electrical connection assembly in-line on a conductor is provided. The method also includes hanging the electrical connection assembly on the conductor. The method also includes tightening a first clamp positioned at a first end portion with a first clamp actuator positioned below the conductor. The method also includes tightening a first clamp positioned at a first end portion with a first clamp actuator positioned below the conductor.

In another embodiment, hanging the assembly on the conductor includes aligning the assembly in a plane parallel to the conductor and where a conductor groove is non-parallel to the conductor. The assembly is rotated into engagement with the conductor, where at a first end the conductor rotates into engagement with a first hook and a first clamp opening on the first clamp, and where at a second end the conductor rotates into engagement with a second hook and a second clamp opening on the second clamp.

According to at least one embodiment, an in-line electrical assembly is provided and has a first clamp positioned at a first end portion and offset at a first angle. A second clamp is positioned at a second end portion and offset at a second angle. At least one insulator is positioned between the first end portion and the second end portion a switch assembly is positioned between the first end portion and the second end portion.

### BRIEF DESCRIPTION OF THE DRAWINGS

FIG. 1 illustrates an example of a power distribution or transmission system with an in-line electrical assembly according to the present disclosure.

FIG. 2 illustrates a side perspective view of the in-line electrical assembly of the present disclosure according to one embodiment, shown in an uninstalled configuration.

FIG. 3 illustrates a side view of the electrical assembly of FIG. 2.

FIG. 4 illustrates a top perspective view of the electrical assembly of FIG. 2 in the process of being installed on a conductor.

FIG. 5 illustrates a top perspective view of the electrical assembly of FIG. 2 installed on the conductor.

FIG. 6 illustrates a top view of the electrical assembly of FIG. 2.

FIG. 7 illustrates an end view of the electrical assembly of FIG. 2.

FIG. 8 illustrates a detailed perspective view of a portion of the electrical assembly in FIG. 2 according to one embodiment of the present disclosure.

FIG. 9 illustrates a detailed perspective view of the clamp in FIG. 8, shown in an installed configuration on a conductor.

FIG. 10 illustrates an exploded view of the electrical assembly of FIG. 2.

FIG. 11 illustrates a side perspective view of an electrical assembly of the present disclosure according to another embodiment, shown in an uninstalled configuration.

FIG. 12 illustrates a side perspective view of an electrical assembly of the present disclosure according to another embodiment, shown in an uninstalled configuration.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

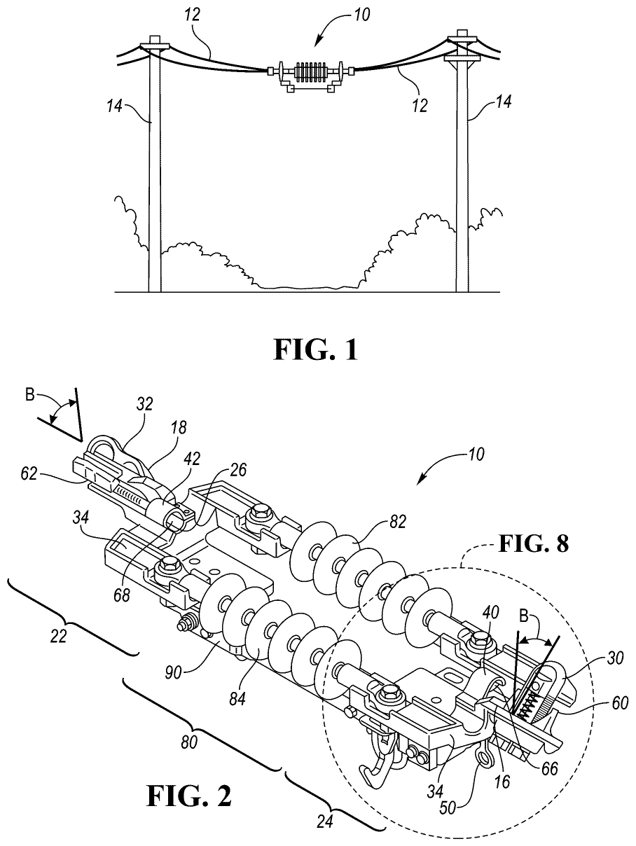

The present application relates to an in-line connection assembly 10. As illustrated in FIG. 1, the in-line connection assembly 10 is configured and sized to be attached to a conductor 12 that spans between two utility poles 14. The assembly 10 may be installed by a utility linemen who may use an extendable reach tool, such as a hot stick when the conductors are live. The in-line connection assemblies may include, but are not limited to, electrical switch mechanisms, such as in-line disconnect switches, knife switches, or other suitable switching devices, in-line tap, or other assemblies for in-line applications. In particular, the in-line connection assembly 10, such as the in-line disconnect switch and the in-line tap, may include end conductor connections sections 16, 18 that allow the assembly 10 to be installed directly along a conductor as a tension switch or a non-tension tap switch. The in-line connection assembly 10 may be used with any type of in-line connection switches. An intermediate connection portion 80 is disposed between the end sections 22, 24. In particular, the in-line connection assemblies 10 according to the present application use clamps to mechanically and electrically secure to the line conductor, facilitating easy and safe installation from below the conductors by a single lineman.

FIG. 2 illustrates an in-line connection assembly 10 being an in-line disconnect switch 20. The in-line disconnect switch 20 has a first conductor connection 16 at a first end section 22 and the second conductor connection 18 at a second end section 24 and the intermediate connection portion 80 is positioned between the first and second end sections 22, 24.

The first and second end sections 22, 24 include a clamp 30, 32 and a bracket 40, 42 for hanging the conductor that allows the in-line disconnect switch 20 to be installed with a single lineman. The brackets 40, 42 are shaped to allow for the in-line disconnect switch 20 to hang on the conductor prior to tightening the clamps 30, 32.

As illustrated, the first end section 22 has a first clamp 30 and the second end section 24 has a second clamp 32, the first and second clamps 30, 32 are each moveable between an open and a closed clamping position. The first end section 22 is generally identical in structure and function to the second end section 24, except that the two are oriented 180 degrees apart. Accordingly, features common to both end sections are described with reference to the first end section 22 and are not repeated separately for the second 24.

The end sections 22, 24 each have an end body 34. The end body 34 has a conductor groove 26 that extends longitudinally along the end body 34. The conductor groove 26 receives a portion of the conductor 12 to align the conductor with the clamp 30, 32.

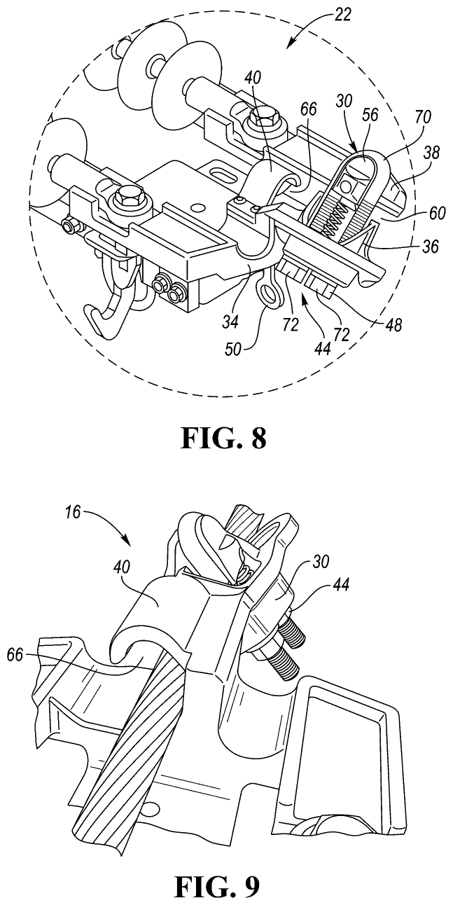

The conductor connection 16 is illustrated in more detail in FIG. 8. The clamps 30, 32 have a first clamp jaw 36 extending from the end body 34. The clamps 30, 32 have a second jaw 38 which is movable relative to the first clamp jaw 36. The conductor 12 is clamped between the first and second clamp jaws 36, 38. As illustrated, the first clamp jaw 36 is a lower jaw, and the second clamp jaw 38 is an upper jaw. The first and second clamp jaws 36, 38 have in inner curved surface for gripping the conductor 12. The inner clamping surfaces of the first and second clamp jaws 36, 38 are curved to correspond closely to the curvature of the conductor being clamped, thereby providing secure engagement and optimal electrical contact. The first and second clamp jaws 36, 38 may be provided in different sizes and with varying curvatures to accommodate conductors of different diameters or ratings. For example, suitable conductor sizes include, but are not limited to, 15 kV, 28 kV, 35 kV, or other standard conductor sizes commonly used in electrical distribution and transmission systems.

In the open position, the clamp jaws 36, 38 define a clamp opening 60 configured for lateral insertion of a conductor into the clamps 30, 32. Specifically, the first clamp 30 is oriented such that first jaw opening 60 faces toward the right side of the assembly, enabling the conductor 12 to be inserted from the right side. Conversely, the second clamp 32 is oriented with its clamp opening 62 facing toward the left side of the assembly 10, facilitating conductor insertion from the left side. This opposite-facing orientation of the clamp openings 60, 62 allows casy of installation in a horizontal plane, as will be discussed in more detail.

The in-line electrical connection assembly 10 also includes first and second brackets 40, 42 extending from the respective end body 34. The brackets 40, 42 support and stabilize the in-line connection assembly 10 when it is initially placed onto a conductor 12 before the clamps 30, 32 are tightened to their closed positions. By providing this preliminary support, the brackets 40, 42 simplify the installation process, allowing a single installer to securely position the in-line connection assembly 10 onto the conductor 12 without needing additional assistance.

Each of the first and second brackets 40, 42 is formed as a hook extending up from the corresponding end body. Specifically, the first bracket 40 includes a hook having a hook opening 66 oriented toward the right side of the assembly, while the second bracket 42 has a hook opening 68 facing toward the left side. This opposing orientation of the hook openings 66, 68 enables secure and balanced engagement with the conductor 12 from opposite directions, enhancing both stability and case of installation.

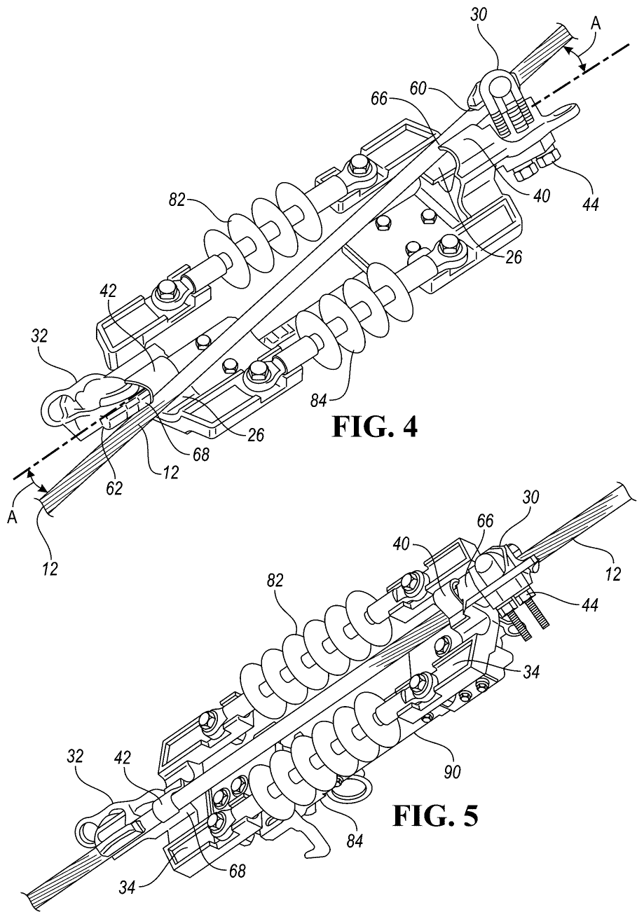

The electrical connection assembly 10 is hung on the conductor 12 by initially bringing the assembly up the conductor 12 from below. As shown in FIG. 4, the assembly 10 is initially positioned with the conductor groove 26 oriented at an angle A non-parallel to the conductor itself. The assembly 10 is then rotated toward the conductor 12, causing the conductor at the first end 22 to rotate into engagement with the first bracket 40 and first hook opening 66 and subsequently enter the opening 60 defined by the first clamp 30. Simultaneously, at the second end 24 of the assembly 10, the conductor 12 rotates into engagement with the second bracket 42 and second hook opening 68 and into the corresponding opening 62 defined by the second clamp 32. This rotational mounting method ensures secure, balanced positioning of the assembly on the conductor, simplifying installation by a single operator.

After the electrical connection assembly 10 has been securely hung onto the conductor 12, the assembly can be secured in place by tightening a first and second clamps 30, 32. The clamps 30, 32 are tighten and the first and second jaws 36, 38 are compressed by operating a first clamp actuator 44. The clamp actuator 44 is positioned conveniently below the conductor 12, thereby enhancing the safety and ergonomics of the installation process so that the lineman never has to position themselves between conductors above the height of the conductor. Similarly, the second clamp 32 at the opposite end portion 24 is tightened using a second clamp actuator 46, also extending below the conductor 12.

The clamp actuators 44, 46 are extend below the lower jaw 36 of the clamp and engage with the upper jaw 38. Adjustment of the clamp actuators 44, 46, such as by tightening or loosening, moves the upper jaw 38 relative to the lower jaw 36, thus transitioning the clamps 30, 32 between open and closed positions. Being able to adjust the clamp actuators 44, 46 from below the lower jaw 36 facilitates convenient access below the conductor during installation and maintenance, enabling a single technician to safely and efficiently operate the clamp from a position beneath the conductor.

As illustrated, each of the clamp actuators 44, 46 includes a fastener 48. A first segment 54 of the fastener 48 engages and cooperates with an aperture 52 on the first clamp jaw 36. A second segment 58 of the fastener 48 engages the second clamp jaw 38. As the threaded section of the fastener 48 extends through the aperture 52, the second clamp jaw 38 is brought closer to the first clamp jaw 36 to capture the conductor 12 between the first and second clamp jaws 36, 38.

The fastener 48 may be a U-bolt or other suitable curved fastener where the first segment 54 has threaded portions at its distal ends. This the second segment 58 may be a curved segment that allows the fastener 48 to be retained on the upper clamp jaw 38, maintaining its position and alignment relative to the clamp components throughout the actuation process. The fastener 48 further comprises nuts having internal threads configured to engage the threaded portions of the bolt. When the torque bearing surface of the nut is gripped with a standard tool, the nuts are rotated relative to the bolt and they actuate the clamp mechanism by drawing the lower and upper jaws 36, 38 toward one another, thereby moving the clamp from an open to a closed position. The fastener, such as the threaded nuts, may be easily tightened using standard tools, such as an impact gun, torque wrench, nut driver, or any other suitable tool. The nuts are strategically positioned on the underside of the clamp 30 to facilitate safer and more ergonomic installation from beneath the conductor 12, particularly while the in-line disconnect switch 20 is suspended on bracket 40. As the nuts are tightened, the clamp 30 compresses to the closed position, ensuring secure mechanical and electrical contact with the conductor 12.

Alternative embodiments for the fastener may also be employed to secure the clamp jaws. For instance, the fastener may comprise a single bolt having a threaded end with threaded engagement directly with the upper jaw 38, with the bolt head accessible from beneath the lower jaw 36 to facilitate rotation during installation. Other threaded fasteners, such as threaded rods or studs, may similarly be utilized. Additionally, embodiments may include captive bolts or screws retained in either jaw 36, 38, enabling convenient one-handed tightening. Alternatively, mechanisms such as cam-action fasteners, wedge fasteners, or toggle bolts could be incorporated, providing rapid clamping action and secure engagement.

As shown in FIG. 2, the first and second clamps 30, 32 are oriented at the angle B from vertical. The orientation of the clamp 30 at the angle B facilitates easy insertion of the conductor 12 into the clamp 30, 32 from the lateral sides and allows the fastener torque-bearing surface to be positioned below the conductor 12 on which the in-line disconnect switch 20 is installed. The clamps 30, 32 are oriented at a non-vertical angle B such that the movement of the upper and lower jaws 36, 38 occurs along a clamp direction offset from the generally vertical axis by a clamp angle greater than zero degrees. The clamp jaws move in a linear direction at the clamp angle.

The conductor connections 16, 18 including the angled clamps 30, 32 and the brackets 40, 42 allow a single person to easily install the in-line connection assembly 10 to be installed at an ergonomic position below the conductor 12. Prior designs required at least two people to install the switch and required both people to be working at a level even with the conductor or above. In situations with multiple conductors, this required linemen to have their upper body positioned between the conductors, making installation of the switch more difficult.

In one embodiment, the clamp 30, 32 may be oriented at an angle B of least 30-degrees. In another embodiment, the angle is less than 60-degrees. In another embodiment, the angle B may be in the range of 35-degrees to 55-degrees. In a further embodiment, the angle may be between 40-degrees and 50-degrees. The angle B may be any suitable angle that allows for stability of the switch on the conductor while providing for ease of installation.

As illustrated, the first and second clamps 30, 32 are oriented at opposite angles relative to the generally vertical direction to facilitate ergonomic installation and stable engagement with the conductor. Specifically, the first clamp 30 may be oriented at a positive angle within a range of approximately 30 to 60 degrees from vertical, while the second clamp may be oriented at a corresponding negative angle within a range of approximately −30 to −60 degrees. This opposing angular arrangement allows the actuators 44, 46 for both clamps 30, 32 to be accessed from below the conductor, simplifying installation by a single technician and ensuring balanced clamping forces at both ends of the in-line connection assembly 10.

The clamps 30, 32 may be spring loaded to keep the clamps 30, 32 in an open position to accept the conductor 12. The clamp 30 is illustrated in the open position in FIG. 4 before the assembly rotates the conductor 12 into engagement with the clamps 30, 32. FIG. 5 shows the clamps 30, 32 in a closed position. Biasing the clamps 30, 32 to the open position facilitates easier installation by allowing the lineman to position the assembly 10 onto the conductor 12 without needing to manually hold the jaws apart or reach above the conductor to pull the clamps 30, 32 open.

The in-line disconnect switch 20 also includes eyebolts 50. The eyebolts 50 allow the in-in-line connection assembly 10 to be installed on live-wires using hot sticks. As such, no other in-line switch provides this advantage. Many prior designs required at least two linemen to install the switch, and it also required the linemen to be at or above the conductor.

Prior switches also used fire-on wedges installed by specific tools with gunpower utilizing firearm-like cartridge. These shotgun-shell tools received constant complaints from field personnel. The shotgun-shell tools are prone to misfires and constant maintenance. For example, as many as fifty-percent of the shotgun shells would misfire during installation. Shells fired too hard would jam the ram of the tool. Constant cleaning and maintenance of the tool was required. The tool's inconsistency caused hotspots on feeders and jumpers. Installation was difficult with prior tools and work practices.

In contrast, an advantage of the in-line connection assembly 10 is that installation only requires a standard fastener tool, such as an impact gun. The installation quickly and reliably secures the in-line connection assembly 10 to the conductor 12. The in-line connection assembly 10 of the present disclosure eliminates the use of the shotgun-shell specialized tools that are more expensive, higher maintenance and have durability issues.

The intermediate section 80 of the in-line connection assembly 10 includes electrical insulators 82, 84. The insulators 82, 84 serve to electrically isolate conductive components of the assembly, thereby preventing unintended current flow between electrically live sections and grounded or neutral structures. This electrical separation is essential to ensure safe operation under both normal and transient voltage conditions, such as during switching or lightning events. In addition to their insulating properties, the insulators 82, 84 provide structural support by maintaining the relative positioning and mechanical stability of the assembly across its span. The electrical insulators 82, 84 may be formed of any suitable insulting material such as a composite, polymer or porcelain. As illustrated, the first insulator 82 extends along a right side of the assembly 10, and the second insulator 84 extends along the left side of the assembly 10. The conductor 12 extends between the insulators 82, 84 and is generally parallel to the central axis of the insulators 82, 84 once fully installed and clamped, as shown in FIGS. 5-6. The insulators 82, 84 have one end connected to the body 34 of the first end section 22 and another end connected to the body 34 of the second end section 24.

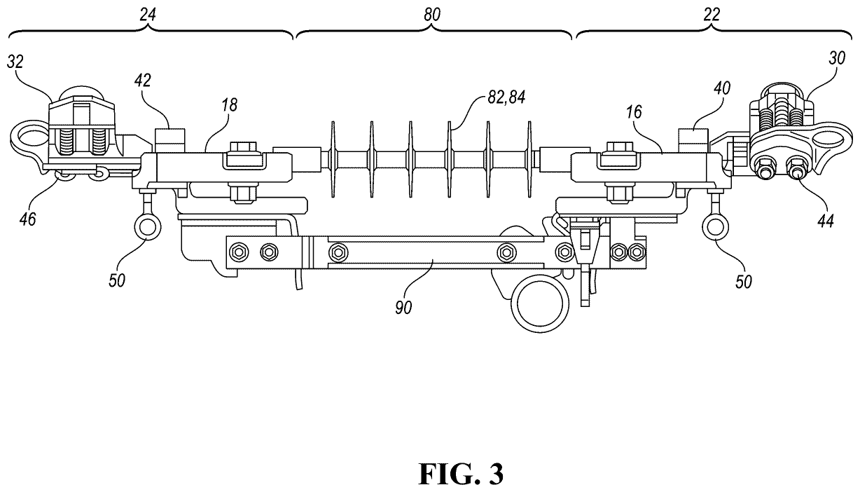

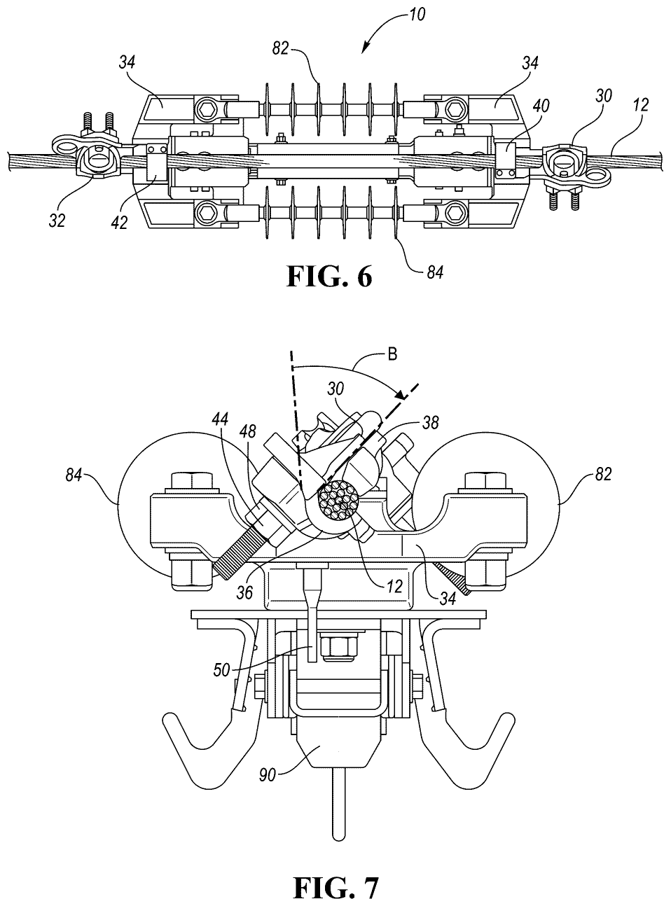

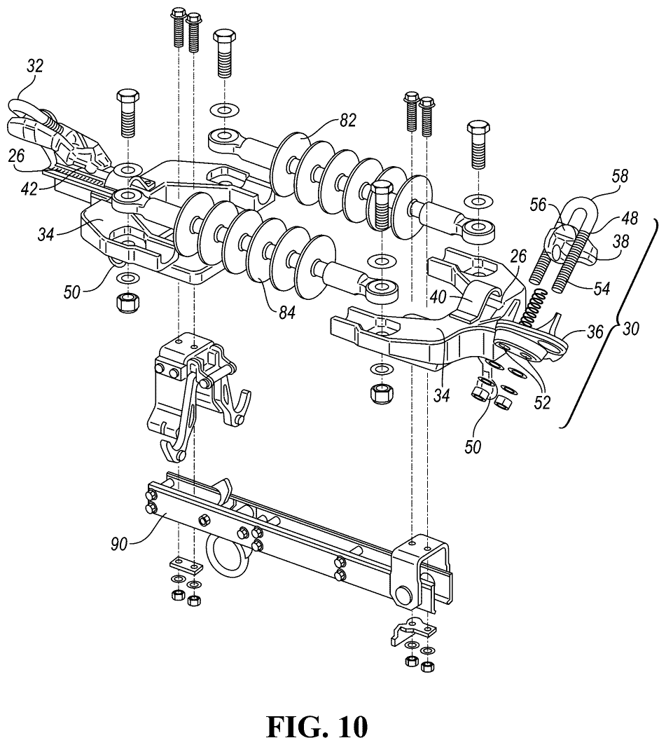

In one embodiment, as illustrated in FIGS. 2-10, the intermediate section 80 of the assembly includes a disconnect switch assembly 90. The switch assembly 90, best shown in FIG. 3, is configured to make and break an electrical connection between the first and second end conductors. The switch assembly 90 may comprise any suitable switching mechanism capable of transitioning between a closed position, in which an electrically conductive path is established between the first and second end conductors, and an open position, in which the conductive path is interrupted. In this manner, the switch assembly 90 enables selective electrical coupling or decoupling of the conductors attached at the first and second ends 22, 24, allowing for controlled isolation or reconnection within the electrical circuit.

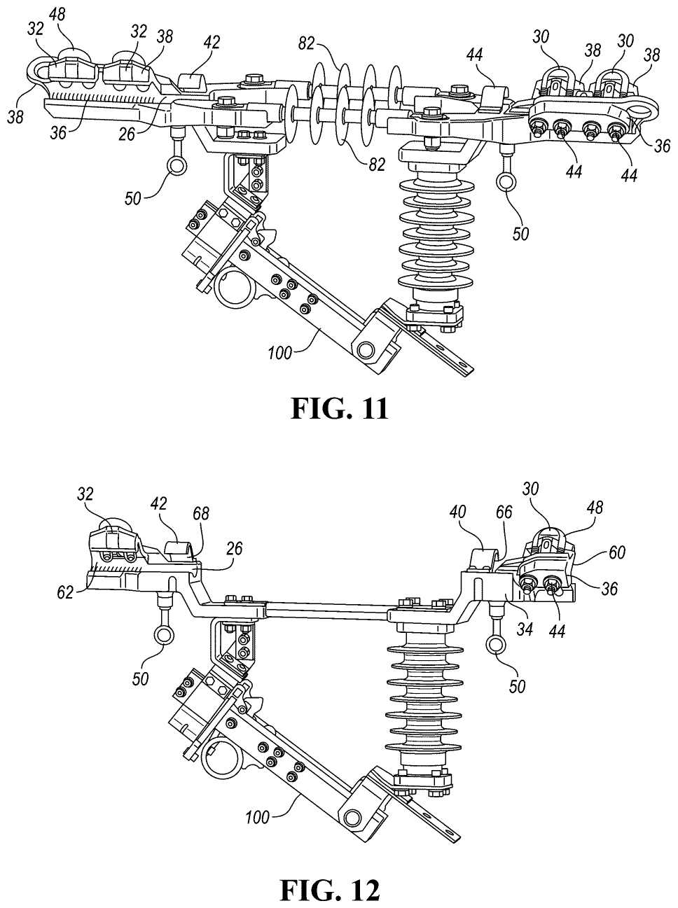

In another embodiment in FIGS. 11-12, the intermediate section of the assembly includes an in-line tap assembly 100 configured to establish an electrical connection between the main conductor and a secondary conductor or device. The tap assembly 100 may comprise any suitable conductive interface that enables current to be diverted from the primary conductor to auxiliary equipment, such as transformers, monitoring devices, reclosers, regulators or lateral distribution lines. The in-line tap 100 forms a continuous electrical path through the main conductor while simultaneously providing a branched conductive path to the tapped output.

As illustrated in FIG. 11, the first and second conductor connections 16, 18 may each include more than one clamp 30, 32. For example, FIG. 11 illustrates two clamps positioned in the end portions 22, 24. Providing more than one clamp at each of the first and second conductor connections 16, 18 enhances the mechanical stability and electrical reliability of the assembly by distributing the clamping force across multiple points of contact with the conductor. This configuration is particularly advantageous in high-load or high-vibration environments, ensuring a secure, low-resistance connection and reducing the risk of loosening or conductor damage over time. This second clamp provides additional strength and overall clamping on conductors allowing for the higher tensile strength needed for larger conductors.

FIG. 12 illustrates an in-line connection assembly 10 having an in-line tap assembly 100 according to another embodiment. The first and second conductor connections 16, 18 may each include one clamp 30, 32 and may not include insulators to provide a lighter assembly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An in-line electrical assembly comprising:
a first clamp positioned at a first end portion and offset at a first angle;
a second clamp positioned at a second end portion and offset at a second angle;
at least one insulator positioned between the first end portion and the second end portion; and
a switch assembly positioned between the first end portion and the second end portion.

2. The in-line electrical assembly of claim 1, wherein the first and second clamps each include a fastener, wherein the fastener is tightened to move the first and second clamps from an open position to a closed position, wherein a fastener torque-bearing surface is below a conductor on which the in-line switch is installed.

3. An in-line connection assembly comprising:
a first end portion having a first conductor clamp and a second end portion having a second clamp, the first and second conductor clamps each comprising:
a first jaw and a second jaw moveable relative to each other between an open position and a closed position where each conductor clamp is positioned to hold an electrical conductor between the first jaw and the second jaw;
a clamp actuator extending below the first jaw and engaged with second jaw, wherein adjustment of the clamp actuator moves the clamp between the open and closed position;
at least one insulator positioned between the first end portion and the second end portion; and
an electrical assembly positioned between the first end portion and the second end portion.

4. The in-line connection assembly of claim 3, wherein the electrical assembly comprises an in-line disconnect switch.

5. The in-line connection assembly of claim 3, wherein the electrical assembly comprises an in-line tap.

6. The in-line connection assembly of claim 3, wherein the first jaw comprises a lower jaw positioned below the conductor and the second jaw comprises an upper jaw moveable to clamp above the conductor.

7. The in-line connection assembly of claim 3, wherein the first jaw comprises an aperture through which the clamp actuator extends, and the clamp actuator is retained on the second jaw.

8. The electrical connection assembly of claim 3, wherein the first and second jaw move linearly in a clamp direction offset from a generally vertical direction by a clamp angle being greater than 0-degrees.

9. The in-line connection assembly of claim 8, wherein the clamp angle is in the range of 30 to 60 degrees.

10. The in-line connection assembly of claim 3, wherein the first and second clamps are oriented at opposite angles relative to the generally vertical direction, wherein a first clamp angle is in the range of 30 to 60 degrees, and a second clamp is in the range of −30 to −60 degrees.

11. The in-line connection assembly of claim 3, wherein in the open position, the first clamp has an opening facing a right lateral side of the assembly, and when the second clamp is in the open position, the second clamp has an opening facing a left lateral side of the assembly.

12. The in-line connection assembly of claim 3, wherein the first end portion comprises a first bracket and the second end portion comprises a second bracket, wherein the first and second brackets support the assembly on the conductor as the clamps are moved to the closed clamp position.

13. The in-line connection assembly of claim 12, wherein the first and second brackets comprise a hook extending from an the end body of the first and second end portions, wherein the first hook has a hook opening to the right side and the second hook has a hook opening to the left side.

14. The in-line connection assembly of claim 3, wherein the first and second clamp actuators each comprise a threaded fastener, wherein the threaded fastener is tightened to move the clamp to the closed position.

15. The in-line connection assembly of claim 14, wherein the fastener comprises a curved fastener having two threaded portions at distal ends.

16. The in-line connection assembly of claim 14, wherein the fastener is retained on the second jaw along a curved segment.

17. The in-line connection assembly of claim 14, wherein the fastener comprises a nut engaging a threaded portion of a bolt, wherein rotating the nut relative to the bolt moves the clamp between the open and closed positions.

18. A method of assembling an electrical connection assembly in-line on a conductor, the method comprising:
hanging the electrical connection assembly on the conductor;
tightening a first clamp positioned at a first end portion with a first clamp actuator positioned below the conductor;
tightening a first clamp positioned at a first end portion with a first clamp actuator positioned below the conductor.

19. The method of claim 18, wherein hanging the assembly on the conductor comprises:
aligning the assembly in a plane parallel to the conductor and where a conductor groove is non-parallel to the conductor; and
rotating the assembly into engagement with the conductor,
wherein at a first end the conductor rotates into engagement with a first hook and a first clamp opening on the first clamp, and
wherein at a second end the conductor rotates into engagement with a second hook and a second clamp opening on the second clamp.

20. The method of claim 18, wherein the first and second clamp actuators comprises a threaded fastener and the threaded fastener is tightened by rotating the fastener with a standard tool.
